(19) United States
(12) Patent Application Publication
(10) Pub. No.: US 2020/0213518 A1
(43) Pub. Date: Jul. 2, 2020

(54) METHOD FOR CONTROLLING GIMBAL, GIMBAL CONTROLLER, AND GIMBAL

(71) Applicant: SZ DJI OSMO TECHNOLOGY CO., LTD., Shenzhen (CN)

(72) Inventors: Tie SU, Shenzhen (CN); Paul PAN, Shenzhen (CN)

(21) Appl. No.: 16/817,082

(22) Filed: Mar. 12, 2020

Related U.S. Application Data
(63) Continuation of application No. PCT/CN2017/103205, filed on Sep. 25, 2017.

(51) Int. Cl. H04N 5/232; F16M 11/10; F16M 11/20; F16M 13/04; F16M 11/18

(52) U.S. Cl. CPC H04N 5/23287; H04N 5/23258; F16M 11/10; F16M 11/2021; F16M 11/2042; F16M 11/2064; F16M 13/04; F16M 11/18; F16M 11/2014

(57) ABSTRACT

A method of controlling a gimbal of a gimbal is provided, the gimbal including a yaw axis arm and a gimbal base in a fixed connection with the yaw axis arm. The method includes, when the gimbal base rotates about a pitch axis, obtaining a yaw attitude of the gimbal base, determining a target yaw attitude of the gimbal according to the yaw attitude of the gimbal base, and controlling an actual yaw attitude of the gimbal according to the target yaw attitude of the gimbal.

### CROSS-REFERENCE TO RELATED APPLICATION

This application is a continuation of International Application No. PCT/CN2017/103205, filed Sep. 25, 2017, the entire content of which is incorporated herein by reference.

### TECHNICAL FIELD

The present disclosure relates to a technical area of unmanned aerial vehicle, and in particular to a method of controlling a gimbal, a gimbal controller, and a gimbal.

### BACKGROUND

Steadicam stabilizes the camera via gravity and helps produce smooth-transitioning pictures and videos.

Hand-held gimbals provide stabilization electronically. Via inertial measurement unit (IMU), the hand-held gimbal calculates out amount of disturbance according to an actual attitude and a target attitude of the camera, executes feedback control via electric motors, offsets the amount of disturbance as calculated, and then to obtain stabilization enhancement electronically.

### SUMMARY

In accordance with the disclosure, there is provided a method of controlling a gimbal, the gimbal including a yaw axis arm and a gimbal base in a fixed connection with the yaw axis arm, the method including when the gimbal base rotates about a pitch axis, obtaining a yaw attitude of the gimbal base, determining a target yaw attitude of the gimbal according to the yaw attitude of the gimbal base, and controlling an actual yaw attitude of the gimbal according to the target yaw attitude of the gimbal.

Also in accordance with the disclosure, there is provided a gimbal controller including a memory and a processor coupled to the memory, the memory storing program instructions executable by the processor to perform a method of controlling a gimbal, the gimbal including a yaw axis arm and a gimbal base in a fixed connection with the yaw axis arm, the method including when the gimbal base rotates about a pitch axis, obtaining a yaw attitude of the gimbal base, determining a target yaw attitude of the gimbal according to the yaw attitude of the gimbal base, and controlling an actual yaw attitude of the gimbal according to the target yaw attitude of the gimbal.

### BRIEF DESCRIPTION OF THE DRAWINGS

Objectives, features, and advantages of the embodiments are more readily understandable in reference to the accompanying drawings described below. In the accompanying drawings, the embodiments are described without limiting the scope of the present disclosure.

FIG. 1 is a schematic structural diagram of a Steadicam according to one embodiment of the present disclosure.

FIG. 2 is a schematic structural diagram of a hand-held gimbal according to another embodiment of the present disclosure.

FIG. 3 is a schematic structural diagram of a hand-held gimbal integrated onto a Steadicam according to yet another embodiment of the present disclosure.

FIG. 4 is a schematic structural diagram of a hand-held gimbal integrated onto a Steadicam according to yet another embodiment of the present disclosure.

FIG. 5 is a schematic structural diagram of a hand-held gimbal integrated onto a Steadicam according to yet another embodiment of the present disclosure.

FIG. 6 is a schematic structural diagram of a hand-held gimbal integrated onto a Steadicam according to yet another embodiment of the present disclosure.

FIG. 7 is a schematic flow chart diagram of a gimbal controlling method according to yet another embodiment of the present disclosure.

FIG. 8 is a schematic structural diagram of a hand-held gimbal integrated onto a Steadicam according to yet another embodiment of the present disclosure.

FIG. 9 is a schematic structural diagram of a hand-held gimbal integrated onto a Steadicam according to yet another embodiment of the present disclosure.

FIG. 10 is a schematic structural diagram of a hand-held gimbal integrated onto a Steadicam according to yet another embodiment of the present disclosure.

FIG. 11 is a schematic diagram of operations of a gimbal according to yet another embodiment of the present disclosure.

FIG. 12 is a schematic flow chart diagram of a gimbal controlling method according to yet another embodiment of the present disclosure.

FIG. 13 is a schematic flow chart diagram of a gimbal controlling method according to yet another embodiment of the present disclosure.

FIG. 14 is a schematic structural diagram of a gimbal controller according to yet another embodiment of the present disclosure.

### DETAILED DESCRIPTION OF THE EMBODIMENTS

The present disclosure is described in view of the embodiments but the embodiments as described do not necessarily limit the scope of any of the claims. To those skilled in the technical art, many suitable changes and improvements may be made to the embodiments. Such suitable changes and improvements are understood to be included in the scope defined by the claims.

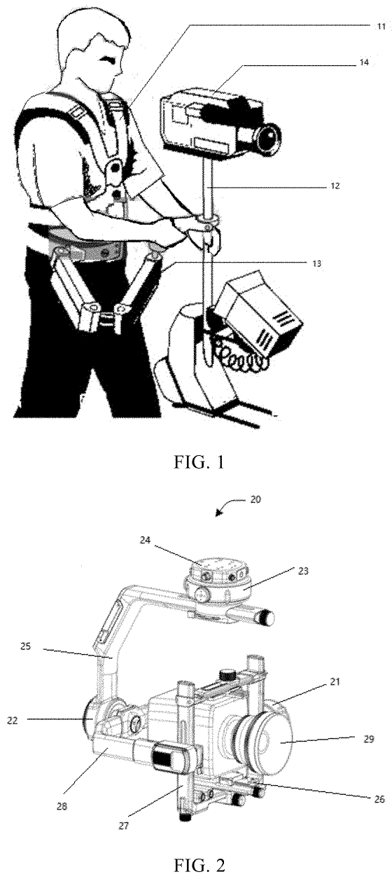

Steadicam stabilizes the camera via gravity and helps produce smooth-transitioning pictures and videos. As illustratively depicted in FIG. 1, the Steadicam includes a support vest 11, a balancing assembly 12, a damper arm 13, a camera 14 positioned on the balancing assembly 12. Steadicam provides quick responses to cameraman's manual maneuver and is particularly responsive to operations along a yaw direction. However, Steadicam has limited resistance to external disturbances largely due to its dependence on gravity for providing stabilization, and therefore is under influence of equipment accuracy and operations by the cameraman. Moreover, Steadicam has limited capacity in stabilization along the roll direction, where pictures as captured are often prone to tilting or being crooked in alignment.

On the other hand, hand-held gimbals provide stabilization electronically. Via inertial measurement unit (IMU), hand-held gimbals calculate out amount of disturbance according to an actual attitude and a target attitude of the camera, executes feedback control via electric motors, offsets the amount of the disturbance as calculated, and then to obtain stabilization enhancement electronically. In addition, hand-held gimbals provide reasonably good controls along the roll attitude, and a result, pictures as captured are not as prone to tilting or being crooked. However, hand-held gimbals are often inadequate in response timeliness or feedback accuracies due to rotations of electric motors.

The hand-held gimbal provides electrical stabilization. FIG. 2 is a schematic structural diagram of a gimbal, and the gimbal may be a hand-held gimbal. As illustratively depicted in FIG. 2, the gimbal 20 includes a pitch axis electric motor 21, a roll axis electric motor 22, a yaw axis electric motor 23, a gimbal base 24, a yaw axis arm 25, a camera support structure 26, a pitch axis arm 27, a roll axis arm 28, and a camera 29. The camera support structure 26 includes inertial measure unit (IMU), where the IMU is employed to detect the attitude of the camera 29. The hand-held gimbal is advantageous in providing relatively strong stabilization, is able to offset small turbulence, and thus is resistant to external disturbance. The stabilization capacity and the accuracy of equipment adjust often do not correlate much to the cameraman. The hand-held gimbal is relatively easy to control along the roll direction, and the pictures as captured are usually well positioned. One of the disadvantages of the hand-held gimbal is slow responses and insufficient accuracy in following rotations of the electric motors.

Steadicam and hand-held gimbal may complement each other, where substantial advantages may be realized when the hand-held gimbal is positioned on the Steadicam, and a camera is in turn supported on the hand-held gimbal. Improved benefits may be realized via a combination where the camera is positioned on the hand-held gimbal, and the hand-held gimbal in turn is supported on the Steadicam, and the camera. However, as the Steadicam moves between higher and lower flight attitudes, the hand-held gimbal as supported on the Steadicam may engage in random and often unwanted rotations, where steady picture-capturing may be impeded during movement between higher and lower flight attitudes.

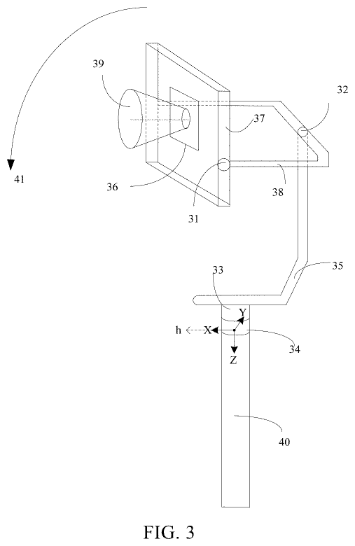

FIG. 3 is a schematic diagram showing an integration of a hand-held gimbal and a Steadicam. As illustratively depicted in FIG. 3, reference numeral 31 represents a pitch axis electric motor of the hand-held gimbal, reference numeral 32 represents a roll axis electric motor of the hand-held gimbal, reference numeral 33 represents a yaw axis electric motor of the hand-held gimbal, reference numeral 34 represents a gimbal base, reference numeral 35 represents a yaw axis arm of the hand-held gimbal, reference numeral 36 represents a support structure of a camber, reference numeral 37 represents a pitch axis arm of the hand-held gimbal, reference numeral 38 represents a roll axis arm of the hand-held gimbal, and reference numeral 39 represents a camera supported on the hand-held gimbal. Reference numeral 40 represents a balancing assembly of a Steadicam. In particular, the hand-held gimbal is in fixed connection to the balancing assembly 40 of the Steadicam via the gimbal base 34. A cameral support system 36 includes an inertial measurement unit (IMU) and the IMU is employed to detect and/or determine an attitude and/or a status of the camera 39.

As illustratively depicted in FIG. 3, X-axis, Y-axis, and Z-axis represent three axes of the coordinate system of the gimbal base 34. When the balancing assembly 40 of the Steadicam is of a shape of a rectangle, the Z-axis of the coordinate system is positioned along an axial direction of the balancing assembly 40, the X-axis of the coordinate system is positioned along a radial direction of the balancing assembly 40, and the coordinate system of the gimbal base 34 is a right-handed coordinate system. Relationship between the coordinate system of the gimbal base 34 and a ground surface coordinate system may be represented with an attitude angle, where the attitude angle reflects an attitude of the gimbal base 34 relative to the ground surface.

Once the hand-held gimbal is supported on the Steadicam, the hand-held gimbal may be in a 2-axis mode or in a 3-axis mode. When in the 3-axis mode, and as illustratively depicted in FIG. 3, the gimbal base 34 is connected to the balancing assembly 40 of the Steadicam, where, when the balancing assembly 40 rotates about the Z-axis, the hand-held gimbal detects that the balancing assembly 40 rotates about the Z-axis, controls the rotation of the yaw axis electric motor 33 of the hand-held gimbal to cause the yaw axis electric motor 33 to rotate as the balancing assembly 40 rotates about the Z-axis. Accordingly, and as the yaw axis electric motor 33 of the hand-held gimbal rotates, the yaw attitude of the hand-held gimbal changes also. Therefore, relative to the 2-axis mode, the 3-axes mode causes the hand-held gimbal to have a slower response in its yaw attitude, and accordingly, the 2-axis mode may be employed to provide the hand-held gimbal with a relatively greater yaw attitude response. In particular, mechanical lock(s) may be employed to lock up the yaw axis electric motor of the hand-held gimbal to de-power the yaw axis electric motor of the hand-held gimbal, where the gimbal base 34 is placed in a fixed connection with the yaw axis arm 35 of the hand-held gimbal for the hand-held gimbal to enter the 2-axis mode. Under the 2-axis mode, the hand-held gimbal may only exert stabilization control on the camera 39 at the pitch direction and the roll direction, while the yaw direction of the hand-held gimbal is stabilization-controlled by the Steadicam.

Once in the 2-axis mode, and as illustratively depicted in FIG. 3, the balancing assembly 40 of the Steadicam rotates about the Z-axis, and the yaw attitude of the hand-held gimbal changes accordingly. The following description is provided with the hand-held gimbal in the 2-axis mode as an example. Locking up the yaw axis electric motor of the 3-axis electric motor is only one way of realizing the 2-axis mode for the hand-held gimbal. Some other suitable methods of realizing the 2-axis mode include situations, for example, when the hand-held gimbal only involves two electric motors, namely the pitch axis electric motor and the roll axis electric motor, and does not include the yaw axis electric motor.

To produce pictures captured at variable angles, or to have pictures as captured by the camera 39 to changes continuously with the angles, the Steadicam that supports the hand-held gimbal may switch between a higher flight or aerial attitude and a lower flight or aerial attitude. In some embodiments, switch of the hand-held gimbal between the higher flight attitude and the lower flight attitude may be realized according to one or more of the following operations.

The first possible operation is to switch between the higher and lower flight attitudes as the hand-held gimbal rotates about the roll axis.

The second possible operation is to switch between the higher and lower flight attitudes as the hand-held gimbal rotates about the pitch axis.

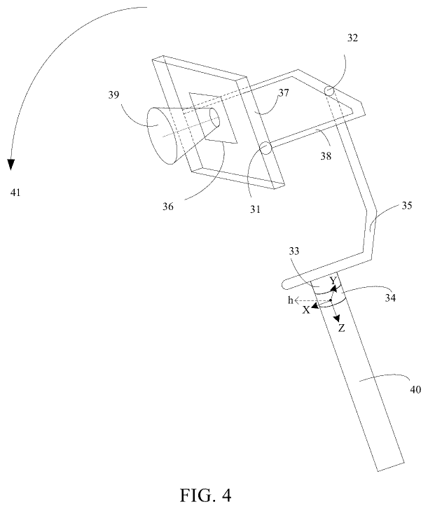

Described below are some of the possible issues associated with the second possible operation. As illustratively depicted in FIG. 3, the Steadicam which supports the hand-held gimbal rotates along the direction shown by arrow 41, in other words, the balancing assembly 40 rotates about the Y-axis of the coordinate system of the gimbal base 34, such that the hand-held gimbal moves from a higher flight attitude to a lower flight attitude while the hand-held gimbal rotates about the pitch axis at the same time, to an attitude such as an attitude illustratively depicted in FIG. 4, and enable generation by the camera 39 of pictures taken both at the higher flight attitude(s) and the lower flight attitude(s).

As illustratively depicted in FIG. 3 and FIG. 4, and as the Steadicam switches from the higher flight attitude to the lower flight attitude, the roll axis arm 38 of the hand-held gimbal changes its angle relative to the horizontal plane. In some embodiments, and as the Steadicam switches from the higher flight attitude to the lower flight attitude, the pitch axis arm of the hand-held gimbal may change along with the roller axis arm 38, and also may not change but keep unchanged.

FIG. 3 and FIG. 4 illustratively depict when the pitch axis arm 37 remains not changed in its attitude relative to the roll axis arm 38. In particular, when the hand-held gimbal detects that the roller axis arm 38 changes in its attitude, the hand-held gimbal controls the pitch axis electric motor 31 to rotate, to keep unchanged the angle between the roller axis arm 38 and the pitch axis arm 37.

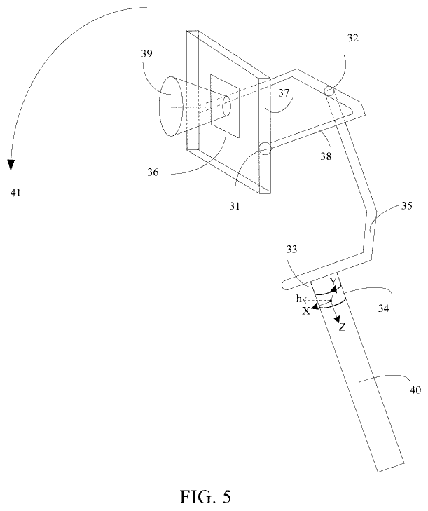

Moreover, and as illustratively depicted in FIG. 3, when moving along the direction 41, the Steadicam which supports the hand-held gimbal may move to an attitude as illustratively depicted in FIG. 5, where the pitch axis arm 37 does not change its attitude relative to the ground surface as the Steadicam switches from the higher flight attitude to the lower flight attitude.

As the hand-held gimbal moves from the higher flight attitude to the lower flight attitude while the hand-held gimbal rotates about the pitch axis at the same time, the pitch axis arm 37 is not limited in its attitude. Taking for example when the pitch axis arm 37 of the hand-held gimbal maintains unchanged its attitude relative to the ground surface, and as illustratively depicted in FIG. 3, and as the roll axis electric motor 32 of the hand-held gimbal rotates, the roll angle of the camera 39 changes too. In other words, the roll axis electric motor 32 of the hand-held gimbal may control the roll angle of the camera 39 and may accordingly keep horizontal the pictures captured by the camera. As the hand-held gimbal switches from the higher flight attitude to the lower flight attitude along the direction shown in arrow 41, the roll axis electric motor 32 of the hand-held gimbal gradually loses its capacity in controlling the roll angle of the camera 39, and as a result the roll angle of the camera 39 gradually becomes under control instead by the yaw axis electric motor 33. When the attitude illustratively depicted in FIG. 3 is regarded as a starting attitude of the hand-held gimbal, as the hand-held gimbal moves along the direction 41 from a higher flight attitude to a lower flight attitude and arrives at an attitude illustratively depicted in FIG. 6, which is an attitude where the roll axis electric motor 32 of the hand-held gimbal is no longer able to control the roll angle of the camera 39. At this time, and if the cameraman somehow causes the roll angle of the camera 39 to change via an operation of the balancing assembly 40, objects in the pictures so captured by the camera 39 may tilt. The hand-held gimbal may exercise control on the attitude of the camera 39 to bring back to a more horizontal plane the pictures captured by the camera 39. When exercising control over the attitude of the camera 39, the hand-held gimbal tends to bring back the pictures to a more horizontal attitude via the shortest possible route. Accordingly, the hand-held gimbal may first attempt to adjust the yaw axis electric motor to bring the pictures to a more horizontal attitude. However, under the 2-axis mode, the gimbal base 34 is already in a fixed connection with the yaw axis arm 35, where the yaw axis electric motor 33 cannot output force, and therefore control of the pictures via the yaw axis electric motor is not feasible. Accordingly, the hand-held gimbal may be able to exercise control on the pictures via only the roll axis electric motor 32 and the pitch axis electric motor 31. This accordingly in turn may cause a non-stop self-adjustment on the attitude of the camera 39 as the roll axis electric motor 32 and the pitch axis electric motor 31 exercise control on the attitude of the camera 39, to cause a possible occurrence where the hand-held gimbal rotates randomly. When the attitude of the camera 39 changes non-stop under the influence of the roll axis electric motor and the pitch axis electric motor, the pictures eventually captured by the camera 39 may no longer be the very pictures originally intended by the cameraman. At this time, the imaging direction of the camera 39 may have been misplaced and therefore may no longer be directed at the target object. FIG. 6 illustratively depicts a possible attitude at which the hand-held gimbal rotates randomly. Other attitudes may exist and be possible, at which the hand-held gimbal may exhibit random rotations as the Steadicam moves from a higher flight attitude to a lower flight attitude.

The Steadicam may switch from a higher flight attitude to a lower flight attitude, may also switch from a lower flight attitude to a higher flight attitude. FIG. 3 through FIG. 6 are for illustrations only and do not necessarily limit the manner how the attitude switch may be realized. In particular, random rotations may occur as the hand-held gimbal switches from a lower flight attitude to a higher flight attitude, for reasons similar to those described in relation to the attitude switches from a higher flight attitude to a lower attitude.

The present disclosure provides a gimbal stabilizing method to overcome some of the issues associated with random rotations when the Steadicam switches between higher and lower flight attitudes.

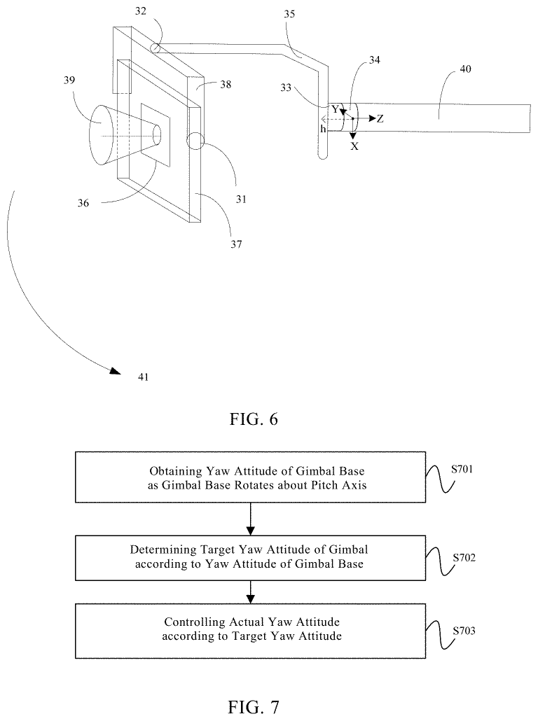

FIG. 7 is a schematic flow chart diagram showing a method of controlling and stabilizing the gimbal, the method including the following step(s).

At step S701, obtaining the yaw attitude of the gimbal base as the gimbal bases rotates about the pitch axis.

The gimbal base is in fixed connection to the yaw axis arm of the gimbal. In some embodiments, the gimbal is a hand-held gimbal, the yaw axis arm of the gimbal is the yaw axis arm 35 of the hand-held gimbal as illustratively depicted in FIG. 3, where the gimbal base 34 is in fixed connection to the yaw axis arm 35 of the hand-held gimbal, in other words, the gimbal base 34 is designed not to move relative to the yaw axis arm 35.

As illustratively depicted in FIG. 3, the X-axis, the Y-axis, and the Z-axis represent the three axes of the coordinate system of the gimbal base 34, and the balancing assembly 40 of the Steadicam is of a shape of a rectangle. In some embodiments, the Z-axis of the coordinate system is along an axial direction of the balancing assembly 40, the X-axis of the coordinate system is along a radial direction of the balancing assembly 40, and the coordinate system of the gimbal base 34 is consistent with a right-handed coordinate system.

The gimbal is in fixed connection to the Steadicam via the gimbal base. In particular, and as illustratively depicted in FIG. 3, the hand-held gimbal is in fixed connection to the balancing assembly 40 of the Steadicam via the gimbal base 34. When the balancing assembly 40 rotates about the X-axis of the coordinate system of the gimbal base 34, the roll angle of the balancing assembly 40 or the gimbal base 34 may change accordingly. The X-axis of the coordinate system of the gimbal base 34 may be regarded as the roll axis of the gimbal base 34. When the balancing assembly 40 rotates about the Y-axis of the coordinate system of the gimbal base 34, the pitch angle of the balancing assembly 40 or the gimbal base 34 may change accordingly. The Y-axis of the coordinate system of the gimbal base 34 may be regarded as the pitch axis of the gimbal base 34. When the balancing assembly 40 rotates about the Z-axis of the coordinate system of the gimbal base 34, the yaw angle of the balancing assembly 40 or the gimbal base 34 may change accordingly. The Z-axis of the coordinate system of the gimbal base 34 may be regarded as the yaw axis of the gimbal base 34.

When the gimbal base 34 rotates about the pitch axis of the gimbal base, the Steadicam causes attitude switch of the gimbal from a higher flight attitude to a lower flight attitude via the gimbal base, and the gimbal base 34 rotates about the pitch axis of the gimbal base 34 to obtain a pitch attitude of the gimbal base 34.

The step of obtaining the yaw attitude of the gimbal base may include: obtaining an actual attitude of the gimbal; obtaining a rotation angle of an electric motor relative to an axis; and determining the yaw attitude of the gimbal base according to the actual attitude of the gimbal and the rotation angle.

As illustratively depicted in FIG. 3 through FIG. 6, a camera supporting structure 36 includes an inertial measurement unit (IMU) which detects an attitude of the camera 39. In other words, the IMU positioned within the camera supporting structure 36 may detect in real time the attitude of the camera 39, where the actual attitude of the camera 39 is the actual attitude of the hand-held gimbal. In addition, and regarding the hand-held gimbal, there is a drive electric motor relative to each of the axes, there is an angle sensor relative to each such drive electric motor, and the angle sensor may detect a rotation angle of the drive electric motor. According to the actual attitude of the gimbal, and according to the rotation angle of the drive electric motor of each of the axes of the hand-held gimbal, the yaw attitude of the gimbal base 34 may be determined.

The step of obtaining the rotation angle of the drive electric motor of each of the axes of the gimbal includes obtaining a pitch rotation angle of a pitch electric motor relative to the pitch axis, a roll rotation angle of a roll electric motor relative to the roll axis, and a yaw rotation angle of a yaw electric motor relative to the yaw axis. In some embodiments, the hand-held gimbal is a 3-axis gimbal including the pitch axis, the yaw axis, and the roll axis, each with a corresponding drive electric motor, as illustratively depicted in FIG. 3 through FIG. 6, where the pitch axis electric motor 31 is the electric motor corresponding to the pitch axis of the gimbal, where the roll axis electric motor 32 is the electric motor corresponding to the roll axis of the gimbal, and where the yaw axis electric motor 33 is the electric motor corresponding to the yaw axis of the gimbal. The angle sensor corresponding to the pitch axis electric motor 31 detects a rotation angle of the pitch axis electric motor 31. The angle sensor corresponding to the roll axis electric motor 32 detects a rotation angle of the roll axis electric motor. The angle sensor corresponding to the yaw axis electric motor 33 detects a rotation angle of the yaw axis electric motor.

In some embodiments, the actual attitude of the hand-held gimbal is expressed in a quaternion, a rotation angle of the drive electric motor relative to the pitch axis of the hand-held gimbal is expressed in a quaternion, a rotation angle of the drive electric motor relative to the roll axis of the hand-held gimbal is expressed in a quaternion, and a rotation angle of the drive electric motor relative to the yaw axis of the hand-held gimbal is expressed in a quaternion, such that 4 quaternions are obtained.

The step of determining the yaw attitude of the gimbal base 34 according to the actual attitude of the gimbal and the rotation angle of the drive electric motor corresponding to each of the axes of the hand-held gimbal includes: multiplying the above 4 quaternions, the resulting quaternion after the multiplication may represent an attitude of the gimbal base 34, where the resulting quaternion after the multiplication becomes an attitude angle or an Euler angle of the gimbal base 34, the Euler angle includes the yaw angle, the roll angle, and the pitch angle of the gimbal base 34, and thereafter the yaw attitude of the gimbal base 34 is determined accordingly.

At step S702, the target yaw attitude of the gimbal is determined according to the yaw attitude of the gimbal base.

When the gimbal base 34 rotates about the pitch axis of the gimbal base 34, the Steadicam is switching between higher and lower flight attitudes. As the Steadicam is switching from the higher flight attitude to the lower flight attitude, the hand-held gimbal may determine the target yaw attitude of the gimbal according to the yaw attitude of the gimbal base 34.

In particular, the step of determining the target yaw attitude of the gimbal according to the yaw attitude of the gimbal base includes: when the pitch attitude of the gimbal base is within a first preset range, determining the target yaw attitude of the gimbal according to the yaw attitude of the gimbal base.

As illustratively depicted in FIG. 3 through FIG. 6, an angle defined between the X-axis of the coordinate system of the gimbal base 34 and the horizontal plane reflects a pitch attitude of the gimbal base 34. If the horizontal direction is represented by “h,” and when the positive half axis of the X-axis of the coordinate system of the gimbal base 34 is positioned above the horizontal plane passing through the coordinate origin, the pitch attitude of the gimbal base 34 is considered as positive, and when the positive half axis of the X-axis of the coordinate system of the gimbal base 34 is positioned below the horizontal plane passing through the coordinate origin, the pitch attitude of the gimbal base 34 is considered as negative.

When the gimbal base 34 is positioned as illustratively depicted in FIG. 3, the positive half axis of the X-axis of the coordinate system of the gimbal base 34 is in alignment with the horizontal direction “h,” the pitch angle of the gimbal base 34 is 0 or of zero degree. As illustratively depicted in FIG. 3 through FIG. 6, and as the gimbal base rotates about the pitch axis of the gimbal base, the Steadicam switches from a higher flight attitude to a lower flight attitude, the positive half axis of the X-axis of the coordinate system of the gimbal base is positioned below a horizontal plane passing through the coordinate origin, an angle between the positive half axis of the X-axis and the horizontal direction “h” gradually increase, and a pitch angle of the gimbal base 34 gradually decreases. As illustratively depicted in FIG. 6, the pitch angle there is minus 90 degrees (−90 C.). Starting from the attitude illustratively depicted in FIG. 6, the pitch angle of the gimbal base 34 may eventually become smaller than minus 90 degrees if rotation continues in the direction of 41. In some embodiments, and as the Steadicam switches from a higher flight attitude to a lower flight attitude, and when the pitch attitude of the gimbal base 34 is within a first present range, the hand-held gimbal determines the target yaw attitude of the hand-held gimbal according to the yaw attitude of the gimbal base 34. The first preset range may be a range of minus 105 degrees to minus 75 degrees. In other words, and as the gimbal base 34 continuously rotates about the pitch axis of the gimbal base 34, the Steadicam switches from the higher flight attitude to the lower flight attitude, and when the pitch angle of the gimbal base 34 is greater than minus 105 degrees and smaller than minus 75 degrees, the hand-held gimbal determines the target yaw attitude of the gimbal according to the yaw attitude of the gimbal base 34.

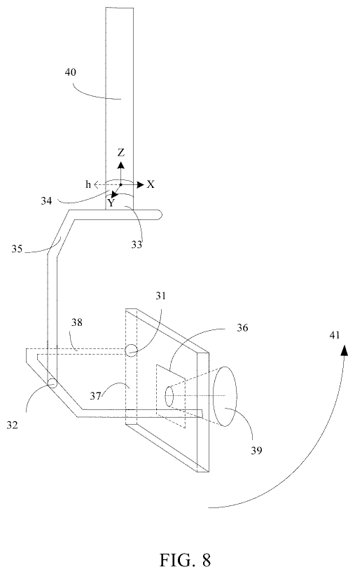

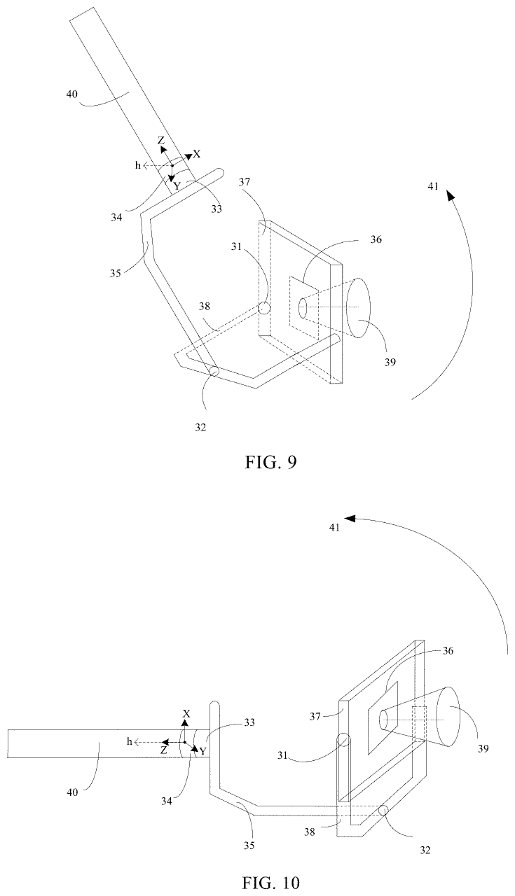

Moreover, as the gimbal base 34 rotates about the pitch axis of the gimbal base 34, the Steadicam switches from a higher flight attitude to a lower flight attitude. For example, and as illustratively depicted in FIG. 8, the Steadicam supporting the gimbal may switch from a starting attitude as illustratively depicted in FIG. 8 and moves along direction 41. When the gimbal base 34 is at an attitude illustratively depicted in FIG. 8, the positive half axis of the X-axis of the coordinate system of the gimbal base 34 is in an opposite direction relative to the horizontal direction “h,” the pitch angle of the gimbal base 34 is 180 degrees or 180 C. As illustratively depicted in FIG. 8, FIG. 9, and FIG. 10, as the gimbal base 34 continuously rotates about the pitch axis of the gimbal base 34, the Steadicam switches from a lower flight attitude to a higher flight attitude, the positive half axis of the X-axis of the gimbal base 34 is positioned above a horizontal plan passing through the coordinate origin, an angle between the positive half axis of the X-axis and the horizontal direction “h” gradually decreases, the pitch angle of the gimbal base 34 gradually decreases. As illustratively depicted in FIG. 10, the pitch angle of the gimbal base is of 90 degrees. Starting from the attitude shown in FIG. 10, the pitch angle of the gimbal base 34 will eventually become small than 90 degrees as the rotation continues along direction 41. In some embodiments, as the Steadicam switches from a lower flight attitude to a higher flight attitude, and when the pitch attitude of the gimbal base 34 is within a first preset range, the hand-held gimbal determines the target yaw attitude of the gimbal according to the yaw attitude of the gimbal base 34. At this attitude, the first present range is a range of from 75 degrees to 105 degrees. In other words, as the gimbal base 34 continues to rotate about the pitch axis of the gimbal base 34, the Steadicam switches from a lower flight attitude to a higher flight attitude, the pitch angle of the gimbal base 34 is greater than 75 degrees and smaller than 105 degrees, the hand-held gimbal determines the target yaw attitude of the gimbal according to the yaw attitude of the gimbal base 34.

In some embodiments, the target roll attitude of the gimbal may be zero or 0. As illustratively depicted in FIG. 3, as the roll electric motor 32 of the hand-held gimbal rotates, the roll attitude of the hand-held gimbal changes accordingly to cause tilting of the pictures captured by the camera 39. To avoid tilting of the pictures captured by the camera 39, the target roll attitude of the hand-held gimbal is set to zero or 0, and the hand-held gimbal is to calculate out an attitude difference between the actual roll attitude and the target roll attitude according to the actual roll attitude and the target roll attitude of the hand-held gimbal. A torque of the roll axis electric motor 32 is determined according to the attitude difference via a closed-loop control, the torque is transmitted to the roll axis electric motor 32 to cause the roll axis electric motor 32 to rotate, to then cause the hand-held gimbal to smoothly transit from the actual roll attitude to the target roll attitude zero.

When the gimbal base 34 rotates about the pitch axis of the gimbal base 34, the Steadicam switches from a lower flight attitude to a higher flight attitude, or from a higher flight attitude to a lower flight attitude.

For example, as the Steadicam switches from a higher flight attitude to a lower flight attitude, and when the pitch attitude of the gimbal base 34 is within a range of minus 105 degrees to minus 75 degrees, the hand-held gimbal may determine the target yaw attitude of the hand-held gimbal according to the yaw attitude of the gimbal base 34. Under these circumstances, movement of the hand-held gimbal toward the target roll attitude zero (0 degree) may be smoothly achieved without necessarily having to control the actual roll attitude of the hand-held gimbal. As the Steadicam switches from a higher flight attitude to a lower flight attitude, and the pitch attitude of the gimbal base 34 is outside of a range of minus 105 degrees or −105 degrees to minus 75 degrees or −75 degrees, the hand-held gimbal controls the actual roll attitude of the hand-held gimbal to ensure smooth movement of the hand-held gimbal toward the target roll attitude zero or 0.

For example, as the Steadicam switches from a lower aerial or flight attitude to a higher aerial or flight attitude, and when the pitch attitude of the gimbal base 34 is within a range of 75 degrees to 105 degrees, the hand-held gimbal determines the target yaw attitude of the hand-held gimbal according to the yaw attitude of the gimbal base 34. Under these circumstances, movement of the hand-held gimbal toward the target roll attitude zero or 0 may be smoothly carried out without necessarily having to require control of the actual roll attitude of the hand-held gimbal. As the Steadicam switches from a lower flight attitude to a higher flight attitude, and when the pitch attitude of the gimbal base 34 is outside of a range of 75 degrees to 105 degrees, the hand-held gimbal controls the actual roll attitude of the hand-held gimbal to ensure smooth transition of the hand-held gimbal to the target roll attitude of zero or 0.

At step S703, the actual yaw attitude of the gimbal is controlled according to the target yaw attitude of the gimbal.

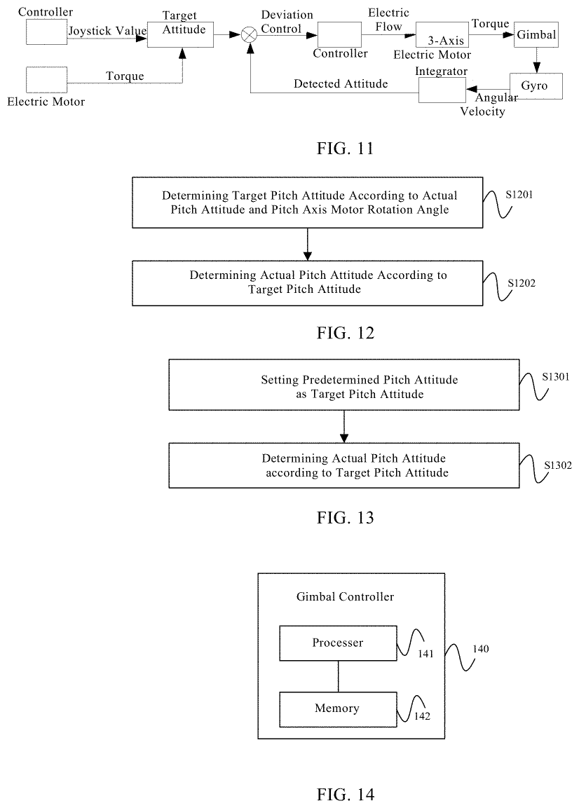

FIG. 11 is a schematic diagram showing operation of the gimbal. In particular, the inertial measurement unit (IMU) of the gimbal includes a 3-axis accelerometer and a 3-axis gyro, where the gyro is employed to detect angular velocities of the 3 axes of the gimbal, and the measured attitude or the actual attitude of the gimbal may be obtained via integration calculation of the angular velocities of the 3 axes of the gimbal. In addition, the target attitude of the gimbal may be obtained according to the torque of the electric motor and the joystick value of a remote controller. Moreover, a deviation may be obtained according to the actual attitude and the target attitude of the gimbal, a controller of the gimbal controls electric flows of the 3-axis electric motor according to the deviation, to produce torque via rotation of the 3-axis electric motor, to then change an actual attitude of the gimbal, to eventually cause a smooth transition of the gimbal from the actual attitude to the target attitude.

In view of the operational mechanism of the gimbal illustratively depicted in FIG. 11, when the actual yaw attitude of the gimbal is controlled via the target yaw attitude of the gimbal, and according to the attitude difference between the target yaw attitude and the actual yaw attitude of the gimbal, close-loop control may be employed to calculate out the target electric motor torque according to the attitude difference, and then the torque is transmitted to the target electric motor for a feedback control.

In some embodiments, the step of controlling the actual yaw attitude of the gimbal according to the target yaw attitude of the gimbal includes: controlling rotation of the roll axis electric motor of the gimbal to effectuate a smooth transition of the gimbal from its actual yaw attitude to a target yaw attitude.

Further in view of FIG. 3 through FIG. 6 and FIG. 8 through FIG. 10, as the gimbal base 34 rotates about the pitch axis of the gimbal base 34, the roll axis electric motor 32 of the hand-held gimbal gradually loses capacity in controlling the roll angle of the camera 39, while the capacity of the roll axis electric motor 32 of the hand-held gimbal in controlling the yaw angle of the camera 39 gradually increases. When the gimbal base 34 rotates to its attitude as illustratively depicted in FIG. 6 or FIG. 10, the roll axis electric motor 32 of the hand-held gimbal is no longer able to control the roll angle of the camera 39. At this time, if the roll angle of the camera 39 changes due to for example operations by the cameraman, the target objects in the pictures captured by the camera 39 may tilt or become crooked. To avoid random rotation of the gimbal and to avoid tilting of the picture plane as captured by the camera 39, the hand-held gimbal determines the target yaw attitude of the hand-held gimbal according to the yaw attitude of the gimbal base 34. In some embodiments, the target yaw attitude of the hand-held gimbal is the yaw attitude of the gimbal base, and via controlling the roll axis electric motor 32 of the hand-held gimbal, smooth transition of the hand-held gimbal from its actual yaw attitude to the target yaw attitude may thus be carried out. In other words, via causing a smooth transition of the actual yaw attitude of the hand-held gimbal toward the yaw attitude of the gimbal base 34, the actual yaw attitude of the hand-held gimbal may be controlled via changes in the yaw attitude of the gimbal base 34.

FIG. 6 illustratively depicts an exemplary attitude of the hand-held gimbal when the hand-held gimbal is engaged in a random rotation. As illustratively depicted in FIG. 6, the pitch angle of the gimbal base 34 is minus 90 degrees. As the Steadicam switches from a higher flight attitude to a lower flight attitude, and the pitch attitude of the gimbal base 34 is within a range of minus 105 degrees to minus 75 degrees, the hand-held gimbal may engage in random rotations. To avoid random rotations, the actual yaw attitude of the hand-held gimbal may be controlled to change along with the yaw attitude of the gimbal base 34.

FIG. 10 is a schematic diagram showing an exemplary attitude of the hand-held gimbal as the hand-held gimbal is engaged in random rotations, where the pitch angle of the gimbal base 34 is 90 degrees. As the Steadicam transits or switches from a lower flight attitude to a higher flight attitude, and the pitch attitude of the gimbal base 34 is within a range of 75 degrees to 105 degrees, the hand-held gimbal may engage in random rotations. To avoid such random rotations, the actual yaw attitude of the hand-held gimbal may be controlled to change along with the yaw attitude of the gimbal base 34.

The hand-held gimbal may be connected to support components or structures other than or in addition to the balancing assembly of the Steadicam. These other support components and structures may be in fixed connection to the gimbal base of the hand-held gimbal.

In some embodiments, as the gimbal base rotates about the pitch axis of the gimbal base, the actual yaw attitude of the gimbal may be determined according to the yaw attitude of the gimbal base. Further according to the target yaw attitude of the gimbal, the actual yaw attitude of the gimbal is controlled to cause the actual yaw attitude of the gimbal to change along with the yaw attitude of the gimbal base, and to avoid random rotations of the gimbal during switch between higher and lower flight attitudes. When the gimbal base is in fixed connection to the balancing assembly of the Steadicam, the imaging direction of the camera is in alignment with the pointing direction of the balancing assembly. Under these circumstances, issues associated with crooked imaging direction of the camera due to random rotations may be reduced, such that the camera may produce steady images and pictures during attitude switches between higher and lower flight attitudes.

The present disclosure provides a gimbal control method. As illustratively depicted in FIG. 7, and when the pitch attitude of the gimbal base is within a first present range, the step of determining the actual yaw attitude of the gimbal according to the yaw attitude of the gimbal base may include the following step(s).

When the pitch attitude of the gimbal base is within the first preset range, the step of determining the gimbal's target yaw attitude according to the yaw attitude of gimbal base includes: when the pitch attitude of the gimbal base is within the first preset range and when the rotation angle of the roll axis electric motor of the gimbal is within a second present range, determining the actual yaw attitude of the gimbal according to the yaw attitude of the gimbal base.

As illustratively depicted in FIG. 3 through FIG. 6, and as the gimbal base 34 continuously rotates about the pitch axis of the gimbal base 34, the Steadicam transits from a higher flight attitude to a lower flight attitude, the roll axis electric motor 32 of the hand-held gimbal may rotate. Under these circumstances, when determining the target yaw attitude of the hand-held gimbal according to the yaw attitude of the gimbal base 34, the hand-held gimbal takes into consideration not only a pitch angle range of the gimbal base 34 but also a rotation angle range of the roll axis electric motor 32. In some embodiments, when the pitch angle of the gimbal base 34 is within the first preset range and the rotation angle of the roll axis electric motor 32 is within the second preset range, the hand-held gimbal determines the target yaw attitude of the hand-held gimbal according to the yaw attitude of the gimbal base 34. The second preset range may be from minus 20 degrees to 20 degrees.

In some embodiments, as the gimbal base 34 continuously rotates about the pitch axis of the gimbal base 34, the Steadicam transits from a higher flight attitude to a lower flight attitude, where the pitch angle of the gimbal base 34 is greater than minus 105 degrees and smaller than minus 75 degrees. When the rotation angle or the joint angle of the roll axis electric motor 32 is greater than minus 20 degrees and smaller than 20 degrees, the actual yaw attitude of the hand-held gimbal is determined according to the yaw attitude of the gimbal base 34.

Similarly, as the gimbal base 34 rotates about the pitch axis of the gimbal base 34, the Steadicam transits from a lower flight attitude to a higher flight attitude, and when the pitch angle of the gimbal base 34 is greater than 75 degrees and smaller than 105 degrees, and when the rotation angle or the joint angle of the roll axis electric motor 32 is greater than minus 20 degrees and smaller than 20 degrees, the target yaw attitude of the hand-held gimbal is determined according to the yaw attitude of the gimbal base 34.

In some embodiments, the step of determining the target yaw attitude of the gimbal according to the yaw attitude of the gimbal base includes setting the target yaw angle of the gimbal as the yaw angle of the gimbal base. In particular, the hand-held gimbal sets the target yaw angle of the gimbal as the yaw angle of the gimbal base. The yaw angle of the gimbal base is the actual attitude of the hand-held gimbal. The actual yaw angle of the gimbal base 34 is determined according to rotation angles of the electric motor relative to each of the axes of the hand-held gimbal.

To avoid tilting of the pictures captured by the camera 39, the target roll attitude of the hand-held gimbal is set at zero or 0. As the Steadicam transits from a higher flight attitude to a lower flight attitude, and when the pitch angle of the gimbal base 34 is greater than minus 105 degrees and smaller than minus 75 degrees, and the rotation angle of the roll axis electric motor is greater than minus 20 degrees and smaller than 20 degrees, smooth transition of the hand-held gimbal to the target roll attitude of zero may be realized without necessarily having to have the actual roll axis of the hand-held gimbal controlled. When the pitch attitude of the gimbal base 34 is outside of a range of from minus 105 degrees to minus 75 degrees, and/or the rotation angle of the roll axis electric motor is outside of a range of from minus 20 degrees to 20 degrees, the hand-held gimbal controls the actual roll attitude to ensure a smooth transition toward the target roll attitude of zero.

Similarly, as the Steadicam transits from a lower flight attitude to a higher flight attitude, and when the pitch angle of the gimbal base is greater than 75 degrees and smaller than 105 degrees, and when the rotation angle of the roll axis electric motor 32 is greater than minus 20 degrees and smaller than 20 degrees, smooth transition of the hand-held gimbal toward the target roll attitude of zero may be realized without necessarily having to have the actual roll attitude of the hand-held gimbal controlled. When the pitch attitude of the gimbal base 34 is outside the range of 75 degrees to 105 degrees, and/or the rotation angle of the roll axis electric motor is outside the range of minus 20 degrees to 20 degrees, the hand-held gimbal controls its actual roll attitude to ensure a smooth transition toward the target roll attitude of zero.

In some embodiments, when the pitch attitude of the gimbal base is within the first preset range, the step of determining the target yaw attitude of the gimbal according to the yaw attitude of the gimbal base includes: when the pitch attitude of the gimbal base is within the first preset range and the rotation angle of the roll axis electric motor is within the third preset range, determining the target yaw attitude of the gimbal according to the yaw attitude of the gimbal base.

In some embodiments, the third preset range is between 160 degrees to 200 degrees. In some embodiments, as the gimbal base 34 rotates about the pitch axis of the gimbal base, the Steadicam transits from a higher flight attitude to a lower flight attitude, when the pitch angle of the gimbal base is greater than minus 105 degrees and smaller than minus 75 degrees, and when the rotation angle of the roll axis electric motor 32 is greater than 160 degrees and smaller than 200 degrees, the target yaw attitude of the hand-held gimbal is determined according to the yaw attitude of the gimbal base 34.

Similarly, as the gimbal base 34 rotates about the pitch axis of the gimbal base 34, the Steadicam transits from a lower flight attitude to a higher flight attitude, when the pitch angle of the gimbal base 34 is greater than 75 degrees and smaller than 105 degrees, and the rotation angle of the roll axis electric motor 32 is greater than 160 degrees and smaller than 200 degrees, the hand-held gimbal determines the target yaw attitude of the hand-held gimbal according to the yaw attitude of the gimbal base 34.

In some embodiments, the step of determining the target yaw attitude of the gimbal according to the yaw attitude of the gimbal base includes: Setting the target yaw angle of the gimbal as the yaw angle of the gimbal base minus 180 degrees or plus 180 degrees. In particular, the hand-held gimbal sets the target yaw angle of the gimbal as the yaw angle of the gimbal base minus 180 degrees or sets the target yaw angle of the gimbal as the yaw angle of the gimbal base plus 180 degrees.

To avoid tilting of pictures captured by the camera 39, the target roll attitude of the hand-held gimbal is set at zero or 0. In some embodiments, as the Steadicam transits from a higher flight attitude to a lower flight attitude, when the pitch angle of the gimbal base 34 is greater than minus 105 degrees and smaller than minus 75 degrees, and when the rotation angle of the roll axis electric motor is greater than 160 degrees and smaller than 200 degrees, the hand-held gimbal may transit to the target roll attitude of zero without necessarily having to control the actual roll attitude of the hand-held gimbal. When the pitch attitude of the gimbal base 34 is outside of a range of between minus 105 degrees and minus 75 degrees, and/or the rotation angle of the roll axis electric motor is outside of the range of 160 degrees to 200 degrees, the hand-held gimbal controls the actual roll attitude to ensure a smooth transition toward the target roll attitude of zero.

Similarly, as the Steadicam transits from a lower flight attitude to a higher flight attitude, when the pitch angle of the gimbal base 34 is greater than 75 degrees and smaller than 105 degrees, and when the rotation angle of the roll axis electric motor 32 is greater than 160 degrees and smaller than 200 degrees, the hand-held gimbal may ensure a smooth transition toward the target roll attitude of zero without necessarily having to control the actual roll attitude of the hand-held gimbal. When the pitch attitude of the gimbal base 34 is outside the range of 75 degrees to 105 degrees, and/or the rotation angle of the roll axis electric motor 32 is outside the range of 160 degrees to 200 degrees, the hand-held gimbal controls the actual roll attitude to effectuate a smooth transition toward the target roll attitude of zero.

In addition, when the pitch attitude of the gimbal base is outside of the first preset range, and/or the rotation angle of the roll axis electric motor of the gimbal is outside of the second preset range, the target yaw attitude of the gimbal may be set as the actual yaw attitude of the gimbal.

For example, as the Steadicam transits from a higher flight attitude to a lower flight attitude, when the pitch attitude of the gimbal base 34 is outside of the range of minus 105 degrees and minus 75 degrees, and/or the rotation angle of the roll axis electric motor 32 is outside of the range of minus 20 degrees to 20 degrees, the hand-held gimbal sets the target yaw attitude as the actual yaw attitude, instead of determining according to the yaw attitude of the gimbal base.

Moreover, when the pitch attitude of the gimbal base is outside of the first preset range, and/or the rotation angle of the roll axis electric motor is outside of the third preset range, the target yaw attitude of the gimbal is set as the actual yaw attitude of the gimbal.

For example, as the Steadicam transits from a higher flight attitude to a lower flight attitude, and when the pitch attitude of the gimbal base 34 is outside the range of minus 105 degrees to minus 75 degrees, and/or the rotation angle of the roll axis electric motor 32 is outside the range of 160 degrees to 200 degrees, the target yaw attitude of the gimbal is the actual yaw attitude of the gimbal, and is not determined according to the yaw attitude of the gimbal base.

In some embodiments, when the pitch attitude of the gimbal base is within the first preset range and the rotation angle of the roll axis electric motor is within the second or third preset range, the target yaw attitude of the gimbal is determined according to the yaw attitude of the gimbal base. In other words, to determine the target yaw attitude of the gimbal according to the yaw attitude of the gimbal base, what may be required for consideration includes a range of the pitch angle of the gimbal base and a range of the rotation angle of the roll axis electric motor, so as to increase the accuracy of the target yaw attitude of the gimbal and to improve on gimbal's control efficiency.

FIG. 12 is a schematic diagram of a gimbal control method. FIG. 13 is another schematic diagram of a gimbal control method.

In some embodiments, when the target yaw attitude of the gimbal is set at zero, the step of controlling the gimbal includes: controlling the actual roll attitude of the gimbal according to the target roll attitude of the gimbal.

As illustratively depicted in FIG. 3, as the roll axis electric motor 32 rotates about the hand-held gimbal, the roll attitude of the hand-held gimbal changes accordingly, where the pictures captured by the camera 39 may become crooked. To avoid pictures from tilting or being crooked, the target roll attitude of the hand-held gimbal is set at zero. The hand-held gimbal calculates an attitude difference between the actual roll attitude and the target roll attitude according to the actual roll attitude and the target roll attitude, calculates the torque of the roll axis electric motor 32 via a closed-loop control according to the attitude difference, forwards the torque to the roll axis electric motor 32, to cause the roll axis electric motor to rotate, and eventually effectuate a smooth transition from the actual roll attitude toward the target roll attitude of zero.

As illustratively depicted in FIG. 3 and FIG. 4, as the Steadicam transits from a higher flight attitude to a lower flight attitude, the angle between the roll axis arm 38 of the hand-held gimbal and the horizontal plane changes accordingly. In some embodiments, as the Steadicam transits from a higher flight attitude to a lower flight attitude, the pitch axis arm 37 of the hand-held gimbal may change along with the roll axis arm 38, or may maintain unchanged. FIG. 3 and FIG. 4 illustratively depict situations where the pitch axis arm 37 of the hand-held gimbal remains unchanged relative to the roll axis arm 38. FIG. 3 and FIG. 5 illustratively depict situations where the pitch axis arm 37 of the hand-held gimbal remains unchanged relative to the ground surface.

As the Steadicam transits from a higher flight attitude to a lower flight attitude, and when the pitch axis arm 37 of the hand-held gimbal remains unchanged relative to the roll axis arm 38, the method may include the step(s) illustratively depicted in FIG. 12.

At step S1201, the target pitch attitude of the gimbal is determined according to the actual pitch attitude and the rotation angle of the pitch axis electric motor of the gimbal.

As illustratively depicted in FIG. 3, the actual pitch attitude of the hand-held gimbal is zero, and as the Steadicam moves in the direction 41 from a starting attitude illustratively depicted in FIG. 3, and transits from a higher flight attitude to a lower flight attitude, the angle defined between the roll axis arm 38 of the hand-held gimbal relative to the horizontal plane or horizontal surface changes accordingly. For the pitch axis arm 37 to maintain unchanged in attitude relative to the roll axis arm 38, and when the roll axis arm 38 changes in attitude relative to the ground surface, the hand-held gimbal is to change it attitude relative to the ground surface in response to the attitude change of the roll axis arm 38. The amount of angle rotation that may be required of the pitch axis electric motor 31 is determined, and the target pitch attitude of the hand-held gimbal is determined according to the actual pitch attitude of the gimbal and the amount of angle rotation required of the pitch axis electric motor 31.

At step S1202, the actual pitch attitude of the gimbal is controlled according to the target pitch attitude of the gimbal.

The hand-held gimbal determines the target pitch attitude of the hand-held gimbal, calculates an attitude difference between the actual pitch attitude and the target pitch attitude, and determines the torque of the pitch axis electric motor 31 via a closed-loop control according to the attitude difference. The torque is forwarded to the pitch electric motor 31, to cause the pitch electric motor to rotate, and then to effectuate a transition of the hand-held gimbal from the actual pitch attitude to the target pitch attitude. Accordingly, the pitch axis arm 37 maintains unchanged in attitude relative to the roll axis arm 38.

In addition, as the Steadicam transits from a higher flight attitude to a lower flight attitude, when the pitch axis arm 37 of the hand-held gimbal remains unchanged in attitude relative to the ground surface, the method may further include the step(s) as illustratively depicted in FIG. 13.

At step S1301, the predetermined pitch attitude is set as the target pitch attitude of the gimbal.

As the Steadicam moves along the direction 41 from a starting attitude illustratively depicted in FIG. 3 and transits from a higher flight attitude to a lower flight attitude, the predetermined pitch attitude is set as the target pitch attitude of the hand-held gimbal, where the predetermined pitch attitude may be the pitch attitude of the hand-held gimbal relative to the ground surface. For example, the predetermined pitch attitude may be set at zero.

At step S1302, the actual pitch attitude of the gimbal is controlled according to the target pitch attitude of the gimbal.

As illustratively depicted in FIG. 3, the actual pitch attitude of the hand-held gimbal is set at zero, as the Steadicam moves along direction 41 from a starting attitude as illustratively depicted in FIG. 3 and transits from a higher flight attitude to a lower flight attitude, and if the actual pitch attitude of the hand-held gimbal changes, the hand-held gimbal calculates an attitude difference between the actual pitch attitude and the target pitch attitude which is set at zero. The hand-held gimbal then calculates out the torque of the pitch axis electric motor via a closed-loop control according to the attitude difference, forwards the torque to the pitch axis electric motor, to cause the pitch axis electric motor to rotate, and then to effectuate a transition of the hand-held gimbal from its actual pitch attitude to the target pitch attitude of zero. Accordingly, the pitch axis arm 37 of the hand-held gimbal may remain unchanged in its attitude relative to the ground surface.

In some embodiment, the actual pitch attitude is controlled via determination of the target roll attitude, via control of the actual roll attitude according to the target roll attitude, and via determination of the target pitch attitude, so as to effectuate control over the actual roll attitude and the actual pitch attitude during when the Steadicam switches between higher and lower flight attitudes. Accuracy on controlling the gimbal may thus be realized.

FIG. 14 is a schematic structural diagram of a gimbal controller, where the gimbal controller 140 includes a processor 141, a memory 142, the memory 142 being employed to store computing instructions, the processor 141 executing the computing instruction to perform the following step(s). Obtaining the yaw attitude of the gimbal base when the gimbal bases rotates about the pitch axis of the gimbal base; determining the target yaw attitude of the gimbal according to the yaw attitude of the gimbal base; and controlling the actual yaw attitude of the gimbal according to the target yaw attitude of the gimbal, where the gimbal base is in fixed connection to the yaw axis arm of the gimbal.

In some embodiments, when obtaining the yaw attitude of the gimbal base, the processor is further configured to: obtaining the actual attitude of the gimbal; obtaining the rotation angle of the electric motor relative to each of the axes of the gimbal; and determining the yaw attitude of the gimbal base according to the actual attitude of the gimbal and the rotation angle.

When obtaining the rotation angle of the electric motor relative to each of the axes of the gimbal, the processor 141 is further configured to: obtaining the rotation angle of the electric motor relative to each of the pitch axis, the yaw axis, and the roll axis of the gimbal.

When the pitch attitude of the gimbal base is within the first preset range, the processor 141 is further configured to determine the target yaw attitude of the gimbal according to the yaw attitude of the gimbal base.

When the pitch attitude of the gimbal base is within the first preset range and the rotation angle of the roll axis electric motor of the gimbal is within the second preset range, the processor 141 is further configured to determine the target yaw attitude of the gimbal according to the yaw attitude of the gimbal base. In determining the target yaw attitude of the gimbal according to the yaw attitude of the gimbal base, the processor 141 is further configured to set the target yaw angle of the gimbal as the yaw angle of the gimbal base.

Alternatively, when the pitch attitude of the gimbal base is within the first preset range and the rotation angle of the roll axis electric motor is within the third preset range, the processor 141 is further configured to determine the target yaw attitude of the gimbal according to the yaw attitude of the gimbal base. In determining the target yaw attitude of the gimbal according the yaw attitude of the gimbal base, the processor 141 is further configured to setting the target yaw angle of the gimbal as the yaw angle of the gimbal base minus 180 degrees or plus 180 degrees.

Moreover, in controlling the actual yaw attitude of the gimbal according to the target yaw attitude of the gimbal, the processor 141 is further configured to controlling rotation of the roll axis electric motor of the gimbal to effectuate a transition of the gimbal from the actual yaw attitude to the target yaw attitude.

The gimbal controller is similar to embodiments illustratively depicted in FIG. 7 in theory and/or operation.

As the gimbal base rotates about the pitch axis of the gimbal base, the target yaw attitude of the gimbal is determined according to the yaw attitude of the gimbal base. The actual yaw attitude of the gimbal is controlled according to the target yaw attitude of the gimbal to allow the actual yaw attitude of the gimbal to change along with the yaw attitude of the gimbal base. To avoid random rotations of the gimbal during attitude switch between higher and lower flight attitudes, and when the gimbal base is in fixed connection to the balancing assembly of the Steadicam, the imaging direction of the camera may thus be directed to the instruction direction of the balancing assembly.

Accordingly, issues associated with random rotations of the gimbal and the resultant pictures being crooked may be favorably dealt with, such that the camera is able to steadily produce pictures during switches between higher and lower flight attitudes.

In view of the embodiment(s) illustratively depicted in FIG. 14, and when the target roll attitude of the gimbal is set at zero, the processor 141 is further configured to controlling the actual roll attitude of the gimbal according to the target roll attitude of the gimbal.

The processor 141 is further configured to determining the target pitch attitude of the gimbal according to the actual pitch attitude and the rotation angle of the pitch axis electric motor of the gimbal. The processor 141 may further be configured to setting the predetermined pitch attitude as the target pitch attitude of the gimbal. The processor may further be configured to determining the actual pitch attitude of the gimbal according to the target pitch attitude of the gimbal.

The gimbal controller is similar to embodiments illustratively depicted in FIG. 12 and FIG. 13 in theory and/or operation.

The actual roll attitude of the gimbal is controlled according to the target roll attitude of the gimbal as determined. Control of the actual pitch attitude of the gimbal is realized via determining the target pitch attitude of the gimbal and according to the target pitch attitude as determined. As the Steadicam switches between higher and lower flight attitudes, the gimbal exercises control on the actual roll attitude and the actual pitch attitude, such that the accuracy of controls on the gimbal may thus be improved.

The present disclosure also provides a gimbal. The gimbal includes a yaw axis arm, a pitch axis arm, a roll axis arm, a gimbal base, an electric motor of the yaw axis, an electric motor of the pitch axis, an electric axis of the roll axis, and the gimbal controller described herein, where the gimbal base is in fixed connection with the yaw axis arm.

In some embodiments, the gimbal base is in fixed connection to the Steadicam.

The gimbal as employed in these embodiments is similar to the gimbal described herein elsewhere.

Devices, systems, programs, and methods in actions, orders, steps, and periods, as referenced to in the present disclosure, the claims, and the drawings, may be in any suitable order. In particular, terms such as “first” and “next” may be used to simplify the task of description, but not to imply that such order is necessary.

Several functional units of the embodiments of the present disclosure may be integrated into a processing unit, or may each exist as an independent entity. Each of such units may be presented as a hardware unit or a combination or integration of a hardware and a software.

The software function units may be stored in a computer readable storage medium. The storage medium includes instructions when executed cause to the processor to perform one or more of the steps described herein. Such storage medium may include a U-disk, a mobile hard disk, a read-only memory (ROM), a random-access memory (RAM), and any other suitable storage disks and discs.

The present disclosure is described in view of the embodiments but the embodiments as described do not necessarily limit the scope of any of the claims. Certain embodiments or features of the embodiments described herein may be combined; however, not all such combinations are necessarily required for the solutions to the disclosure. To those skilled in the technical art, many suitable changes and improvements may be made to the embodiments. Such suitable changes and improvements are understood to be included in the scope defined by the claims.

What is claimed is:

1. A method of controlling a gimbal, the gimbal including a yaw axis arm and a gimbal base in a fixed connection with the yaw axis arm, the method comprising:
when the gimbal base rotates about a pitch axis, obtaining a yaw attitude of the gimbal base;
determining a target yaw attitude of the gimbal according to the yaw attitude of the gimbal base; and
controlling an actual yaw attitude of the gimbal according to the target yaw attitude of the gimbal.

2. The method of claim 1, wherein obtaining the yaw attitude of the gimbal base includes:
obtaining an actual attitude of the gimbal;
obtaining a rotation angle of a drive motor relative to an axis; and
determining the yaw attitude of the gimbal according the actual attitude of the gimbal and the rotation angle.

3. The method of claim 2, wherein obtaining the rotation angle of the drive motor relative to the axis includes:
obtaining a yaw rotation angle of a yaw drive motor relative to the yaw axis, a pitch rotation angle of a pitch drive motor relative to the pitch axis, and a roll rotation angle of a roll drive motor relative to a roll axis; and
determining the pitch attitude of the gimbal according the actual attitude of the gimbal and the yaw rotation angle, the pitch rotation angle, and the roll rotation angle.

4. The method of claim 1, wherein determining the target yaw attitude of the gimbal according to the yaw attitude of the gimbal base includes:
when a pitch attitude of the gimbal base is within a first preset range, determining the target yaw attitude of the gimbal according to the yaw attitude of the gimbal.

5. The method of claim 4, wherein, when the pitch attitude of the gimbal base is within the first preset range, determining the target yaw attitude of the gimbal according to the yaw attitude of the gimbal includes:
when the pitch attitude of the gimbal base is within the first preset range and when a roll rotation angle of a roll drive motor relative to a roll axis is within a second preset range, determining the target yaw attitude of the gimbal according to the yaw attitude of the gimbal.

6. The method of claim 5, wherein determining the target yaw attitude of the gimbal according to the yaw attitude of the gimbal includes:
setting a target yaw angle of the gimbal as a yaw angle of the gimbal base.

7. The method of claim 4, wherein, when the pitch attitude of the gimbal base is within the first preset range, determining the target yaw attitude of the gimbal according to the yaw attitude of the gimbal includes:
when the pitch attitude of the gimbal base is within the first preset range and when a roll rotation angle of a roll drive motor relative to a roll axis is within a third preset range, determining the target yaw attitude of the gimbal according to the yaw attitude of the gimbal.

8. The method of claim 7, wherein determining the target yaw attitude of the gimbal according to the yaw attitude of the gimbal base includes:
setting a target yaw angle of the gimbal as the yaw angle of the gimbal base minus 180 degrees; or setting the target yaw angle of the gimbal as the yaw angle of the gimbal base plus 180 degrees.

9. The method of claim 4, wherein determining the actual yaw attitude according to the target yaw attitude of the gimbal includes:
controlling rotation of a roll drive motor relative to a roll axis to move the actual yaw attitude of the gimbal toward the target yaw attitude of the gimbal.

10. The method of claim 1, wherein the target roll attitude of the gimbal is zero.

11. The method of claim 1, wherein the gimbal base of the gimbal is in fixed connection with a Steadicam.

12. A gimbal controller, comprising a memory and a processor coupled to the memory, the memory storing program instructions executable by the processor to perform a method of controlling a gimbal of a gimbal, the gimbal including a yaw axis arm and a gimbal base in a fixed connection with the yaw axis arm, the method including:
when the gimbal base rotates about a pitch axis, obtaining a yaw attitude of the gimbal base;
determining a target yaw attitude of the gimbal according to the yaw attitude of the gimbal base; and
controlling an actual yaw attitude of the gimbal according to the target yaw attitude of the gimbal.

13. The gimbal controller of claim 12, wherein obtaining the yaw attitude of the gimbal base includes:
obtaining an actual attitude of the gimbal;
obtaining a rotation angle of a drive motor relative to an axis; and
determining the yaw attitude of the gimbal according the actual attitude of the gimbal and the rotation angle.

14. The gimbal controller of claim 13, wherein obtaining the rotation angle of the drive motor relative to the axis includes:
obtaining a yaw rotation angle of a yaw drive motor relative to the yaw axis, a pitch rotation angle of a pitch drive motor relative to the pitch axis, and a roll rotation angle of a roll drive motor relative to a roll axis; and
determining the pitch attitude of the gimbal according the actual attitude of the gimbal and the yaw rotation angle, the pitch rotation angle, and the roll rotation angle.

15. The method of claim 12, wherein determining the target yaw attitude of the gimbal according to the yaw attitude of the gimbal base includes:
when a pitch attitude of the gimbal base is within a first preset range, determining the target yaw attitude of the gimbal according to the yaw attitude of the gimbal.

16. The gimbal controller of claim 15, wherein, when the pitch attitude of the gimbal base is within the first preset range, determining the target yaw attitude of the gimbal according to the yaw attitude of the gimbal includes:
when the pitch attitude of the gimbal base is within the first preset range and when a roll rotation angle of a roll drive motor relative to a roll axis is within a second preset range, determining the target yaw attitude of the gimbal according to the yaw attitude of the gimbal.

17. The gimbal controller of claim 16, wherein determining the target yaw attitude of the gimbal according to the yaw attitude of the gimbal includes:
setting a target yaw angle of the gimbal as a yaw angle of the gimbal base.

18. The method of claim 15, wherein, when the pitch attitude of the gimbal base is within the first preset range, determining the target yaw attitude of the gimbal according to the yaw attitude of the gimbal includes:
when the pitch attitude of the gimbal base is within the first preset range and when a roll rotation angle of a roll drive motor relative to a roll axis is within a third preset range, determining the target yaw attitude of the gimbal according to the yaw attitude of the gimbal.

19. The gimbal controller of claim 18, wherein determining the target yaw attitude of the gimbal according to the yaw attitude of the gimbal base includes:
setting a target yaw angle of the gimbal as the yaw angle of the gimbal base minus 180 degrees; or
setting the target yaw angle of the gimbal as the yaw angle of the gimbal base plus 180 degrees.

20. The method of claim 15, wherein determining the actual yaw attitude according to the target yaw attitude of the gimbal includes:
controlling rotation of a roll drive motor relative to a roll axis to move the actual yaw attitude of the gimbal toward the target yaw attitude of the gimbal.
